(19) United States
(12) Patent Application Publication
(10) Pub. No.: US 2026/0169597 A1
(43) Pub. Date: Jun. 18, 2026

(54) CAPACITIVE TOUCHPAD AND ELECTRONIC EQUIPMENT

(71) Applicant: Chipsemi Semiconductor (NingBo) Co., Ltd., Ningbo (CN)

(72) Inventors: Kejia LIU, Ningbo (CN); Yaoguo ZHANG, Ningbo (CN); Yibin WU, Ningbo (CN); Shuai FANG, Ningbo (CN); Bo NIE, Ningbo (CN)

(21) Appl. No.: 19/531,644

(22) Filed: Feb. 5, 2026

Related U.S. Application Data
(63) Continuation of application No. PCT/CN2025/137525, filed on Nov. 25, 2025.

(30) Foreign Application Priority Data
Dec. 11, 2024 (CN) 202411824051.6

(51) Int. Cl. G06F 3/044

(52) U.S. Cl. CPC G06F 3/044

(57) ABSTRACT

The present disclosure relates to the technical field of touchpads and discloses a capacitive touchpad and an electronic equipment. The capacitive touchpad of the present disclosure includes a first circuit board, a second circuit board, a bracket, and a capacitive assembly. The bracket is disposed on a first surface of the first circuit board, and the second circuit board is disposed on the bracket in a direction away from the first surface. A second surface of the second circuit board facing the bracket is disposed opposite to the first surface. The capacitive assembly includes a conductor plate and an electrode plate disposed opposite to the conductor plate.

### CROSS REFERENCE TO RELATED APPLICATIONS

This application is a continuation of PCT Patent Application No. PCT/CN2025/137525, entitled “CAPACITIVE TOUCHPAD AND ELECTRONIC EQUIPMENT,” filed Nov. 25, 2025, which claims priority to Chinese Patent Application No. 2024118240516, entitled “CAPACITIVE TOUCHPAD AND ELECTRONIC EQUIPMENT,” filed on Dec. 11, 2024, each of which is incorporated by reference herein in its entirety.

### TECHNICAL FIELD

The present disclosure relates to the technical field of touchpads, and in particular, to a capacitive touchpad and an electronic equipment.

### BACKGROUND

Currently, touchpads are widely used in the field of consumer electronics, such as laptop computers, game controllers, and the like. In order to enhance the performance of touchpads and meet users' demands, related technologies have added pressure sensors to touchpads to detect the pressing force applied to the touchpad, thereby enabling different operations according to different pressures. Existing pressure detection solutions for touchpads include, but are not limited to, capacitive schemes, strain gauge schemes, and pressure film schemes. However, the strain gauge schemes and pressure film schemes are easily affected by environmental conditions and temperature, resulting in poor detection performance, and generally have drawbacks such as complex structures and high costs. Compared with strain gauge schemes and pressure film schemes, capacitive detection schemes offer higher accuracy and lower cost, and have been widely applied.

In the related technology, the capacitive scheme uses two electrode plates and a conductor plate to form a capacitor. When the surface of the touchpad is pressed, the distance between the two electrode plates and the conductor plate changes, causing changes in the detected capacitances. By detecting the changes in capacitances, the pressure applied to the touchpad can be calculated. However, the accuracy of pressure detection in current capacitive touchpads still cannot fully meet the requirements.

### SUMMARY

The embodiments of the present disclosure are intended to provide a capacitive touchpad and an electronic equipment, thereby improving the accuracy of pressure detection of the touchpad.

To solve the above technical problem, the embodiments of the present disclosure provide a capacitive touchpad, including a first circuit board, a second circuit board, a bracket, and a capacitor assembly. The bracket is disposed on a first surface of the first circuit board, and the second circuit board is disposed on the bracket in a direction away from the first surface. A second surface of the second circuit board is disposed opposite to the first surface, and the second surface is a surface of the second circuit board facing the bracket. The capacitor assembly includes a conductor plate and an electrode plate disposed opposite to the conductor plate. The conductor plate is disposed on the first surface, and the electrode plate is disposed on the second surface. The electrode plate includes a first electrode plate, a first isolation plate arranged around an edge of the first electrode plate, and a second electrode plate arranged around an edge of the first isolation plate facing away from the first electrode plate. The first electrode plate and the second electrode plate are both electrically connected to the second circuit board.

In some embodiments of the present disclosure, an electronic equipment, including the capacitive touchpad described above is further provided.

In some embodiments, the first electrode plate is a receiving electrode plate, the second electrode plate is a transmitting electrode plate.

In some embodiments, the electrode plate further includes a grounding plate and a second isolation plate disposed between the first isolation plate and the second electrode plate. The grounding plate is arranged around an edge of the first isolation plate facing away from the first electrode plate, the second isolation plate is arranged around an edge of the grounding plate facing away from the first isolation plate, and the second electrode plate is arranged around an edge of the second isolation plate facing away from the grounding plate.

In some embodiments, a surface of the electrode plate facing away from the second surface has any one of the following shapes: a regular quadrilateral, a regular hexagon, a regular octagon, or a circle.

In some embodiments, the capacitive touchpad further includes a cover plate, and the cover plate is disposed on a surface of the second circuit board facing away from the bracket.

In some embodiments, the bracket is a rectangular parallelepiped structure having a hollow region, the conductor plate is disposed within the hollow region, and the electrode plate is disposed within the hollow region.

In some embodiments, the bracket includes a bracket body and N cantilever beams extending from the bracket body toward the hollow region, where N is a natural number greater than 0. The second circuit board is connected to free ends of the N cantilever beams of the bracket, and the first circuit board is provided with N limiting holes corresponding one-to-one to the N cantilever beams, with the cantilever beams being configured to enter the limiting holes respectively in response to the second circuit board being pressed.

In some embodiments, a respective elastic member of elastic members is disposed between the first circuit board and each cantilever beam.

In some embodiments, in a direction perpendicular to the first surface of the first circuit board, a projection of the electrode plate on the first circuit board is located within a projection of the conductor plate on the first circuit board.

The technical solution provided by the embodiments of the present disclosure has at least the following advantages:

In some embodiments, the electrode plate includes a first electrode plate, a first isolation plate arranged around an edge of the first electrode plate, and a second electrode plate arranged around an edge of the first isolation plate away from the first electrode plate, such that the first electrode plate and the second electrode plate form a nested structure. When a user presses different regions of the touchpad, the equivalent distance changes between the first electrode plate and the second electrode plate and the conductor plate are substantially the same, and the corresponding capacitance changes are also substantially the same, thereby improving the accuracy of pressure detection of the touchpad. Furthermore, the first isolation plate is disposed between the first electrode plate and the second electrode plate, which isolates the first electrode plate and the second electrode plate from each other, thereby ensuring the accuracy of capacitance signal acquisition and further improving the accuracy of pressure detection for the touchpad.

### BRIEF DESCRIPTION OF THE DRAWINGS

One or more embodiments are exemplified by corresponding figures in the drawings. These exemplary illustrations do not constitute limitations on the embodiments. Elements with the same reference numerals in the drawings represent similar elements. Unless otherwise stated, the drawings are not to scale.

FIG. 1A is a schematic cross-sectional view of a capacitive touchpad in the related art;

FIG. 1B is a schematic top view of two electrode plates on a circuit board in the related art;

FIG. 2A is an exploded schematic view of a capacitive touchpad according to some embodiments of the present disclosure;

FIG. 2B is a schematic cross-sectional view of a capacitive touchpad according to some embodiments of the present disclosure;

FIG. 2C is a schematic top view of the electrode plate on a second circuit board of a capacitive touchpad according to some embodiments of the present disclosure;

FIG. 3 is a sectional view showing the electrode plate and the conductor plate of a capacitive touchpad according to some embodiments of the present disclosure;

FIG. 4A is a schematic top view of the electrode plate according to some embodiments of the present disclosure;

FIG. 4B is a schematic top view of the electrode plate according to some embodiments of the present disclosure;

FIG. 4C is a schematic top view of the electrode plate according to some embodiments of the present disclosure;

FIG. 5 is an exploded schematic view of a capacitive touchpad according to some embodiments of the present disclosure; and

FIG. 6 is a schematic top view of the electrode plate of a capacitive touchpad according to some embodiments of the present disclosure.

### DETAILED DESCRIPTION OF THE EMBODIMENTS

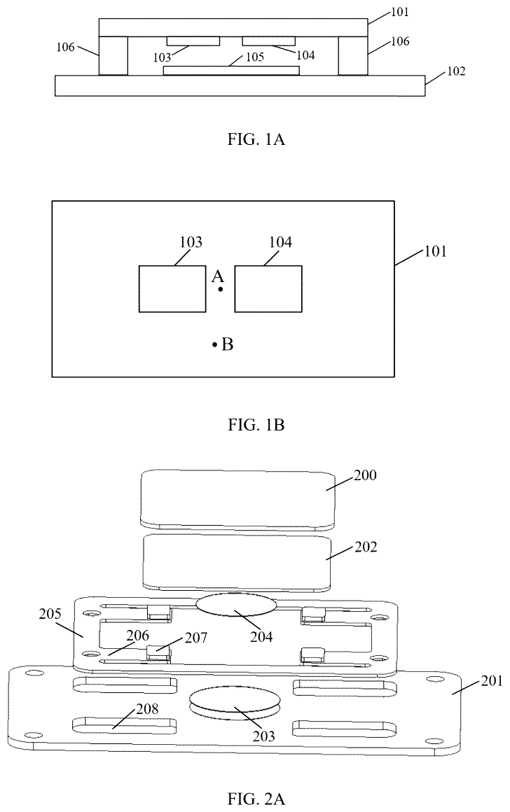

As know from the BACKGROUND, the accuracy of pressure detection of current capacitive touchpads is poor. FIG. 1A shows a schematic cross-sectional view of a capacitive touchpad in related technology. The touchpad includes: an upper circuit board 101, a lower circuit board 102, a transmitting electrode plate 103, a receiving electrode 104, a metal plate 105, and brackets 106. The transmitting electrode plate 103, the receiving electrode plate 104, and the metal plate 105 form a capacitor. In response to the touchpad surface being pressed, the transmitting electrode plate 103 and the receiving electrode plate 104 move downward. The distance between the transmitting electrode plate 103, the receiving electrode plate 104, and the metal plate 105 changes, which in turn leads a change in the detected capacitance. By detecting the changes in capacitance, the pressure exerted on the touchpad can be measured.

Through analysis and research, it is found that when a user performs a pressing operation on different areas of the touchpad, even if the pressing force is the same and the pressing amount at the pressing point on the touchpad is the same, the equivalent distance changes between the transmitting electrode plate 103, the receiving electrode plate 104, and the metal plate 105 are different. FIG. 1B shows a schematic plan view of two electrode plates on a circuit board, for example, if the user presses point A and point B with the same force, when pressing point A, the pressing amount at point A is x, and the pressing amount gradually decreases in the direction away from point A. When pressing point B, the pressing amount at point B is x, and the pressing amount gradually decreases in the direction away from point B. It can be seen that point A is closer to the transmitting electrode plate 103 and the receiving electrode plate 104, and pressing point A may drive the transmitting electrode plate 103 and the receiving electrode plate 104 to move downward by a larger displacement. In contrast, point B is farther from the transmitting electrode plate 103 and the receiving electrode plate 104, and pressing point B causes a smaller downward displacement of the transmitting electrode plate 103 and the receiving electrode plate 104. This results in a large difference in the equivalent distance change between the transmitting electrode plate 103, the receiving electrode plate 104, and the metal plate 105 under the same pressing force, which leads to a large difference in the capacitance change, and thus poor pressure detection accuracy of the touchpad.

In order to solve the problem of relatively poor pressure detection accuracy in the capacitive touchpad schemes in the related art, some embodiments of the present disclosure relate to a capacitive touchpad, including: a first circuit board, a second circuit board, a bracket, and a capacitor assembly. The first circuit board is provided with the bracket on a first surface thereof, and the bracket is provided with the second circuit board in a direction away from the first surface. A second surface of the second circuit board is disposed opposite to the first surface, and the second surface is a surface of the second circuit board facing the bracket. The capacitor assembly includes a conductor plate and an electrode plate disposed opposite to the conductor plate. The conductor plate is disposed on the first surface, and the electrode plate is disposed on the second surface. The electrode plate includes a first electrode plate, a first isolation plate arranged around an edge of the first electrode plate, and a second electrode plate arranged around an edge of the first isolation plate away from the first electrode plate. The first electrode plate and the second electrode plate are both electrically connected to the second circuit board.

In the embodiments of the present disclosure, in the capacitive touchpad provided, the electrode plate is configured to include a first electrode plate, a first isolation plate arranged around an edge of the first electrode plate, and a second electrode plate arranged around an edge of the first isolation plate away from the first electrode plate. That is, the first electrode plate and the second electrode plate form a nested structure. As a result, when a user presses different regions of the touchpad, the equivalent distance changes between the first electrode plate, the second electrode plate and the conductor plate are substantially the same, and the corresponding capacitance changes are also substantially the same, thereby improving the accuracy of pressure detection of the touchpad. Furthermore, the first isolation plate is disposed between the first electrode plate and the second electrode plate, which isolates the first electrode plate and the second electrode plate from each other, thereby ensuring the accuracy of capacitance signal acquisition and further improving the accuracy of pressure detection for the touchpad.

To make the objects, technical solutions, and advantages of embodiments of the present disclosure clearer, the various embodiments of the present disclosure will be described in detail below with reference to the accompanying drawings. However, it should be understood by those skilled in the art that many technical details are provided in the embodiments of the present disclosure in order to facilitate a better understanding of the present disclosure. Nevertheless, even without these technical details and various changes and modifications based on the following embodiments, the technical solutions claimed in the present disclosure can still be realized. The division of the following embodiments is for the sake of description and should not constitute any limitation on the specific implementation of the present disclosure. The various embodiments can be combined and referenced with each other as long as they do not contradict.

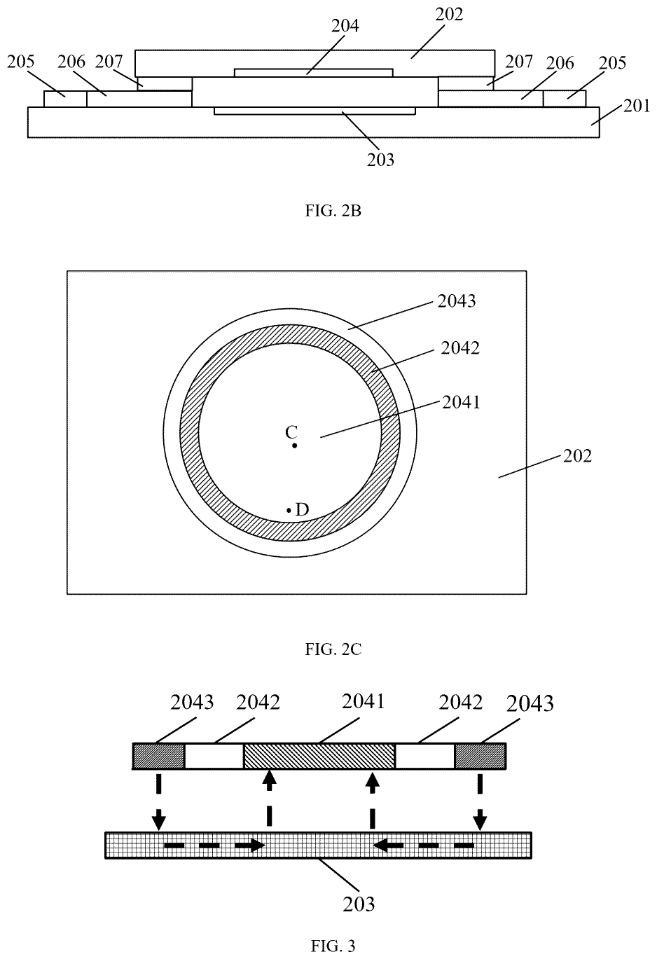

FIG. 2A is an exploded schematic view of a capacitive touchpad according to an embodiment of the present disclosure. FIG. 2B is a schematic cross-sectional view of a capacitive touchpad according to some embodiments. FIG. 2C is a schematic top view of the electrode plates on a second circuit board of a capacitive touchpad according to some embodiments. In some embodiments, the capacitive touchpad includes: a first circuit board 201, a second circuit board 202, a bracket (including a bracket body 205 and cantilever beams 206), and a capacitor assembly (including a conductor plate 203 and an electrode plate 204).

Specifically, the bracket is disposed on a first surface of the first circuit board 201, and the second circuit board 202 is disposed on the bracket in a direction away from the first surface of the first circuit board 201. A second surface of the second circuit board 202 is disposed opposite the first surface, where the second surface is the surface of the second circuit board 202 facing the bracket. The capacitor assembly includes a conductor plate 203 and an electrode plate 204 disposed opposite the conductor plate 203. The conductor plate 203 is disposed on the first surface, and the electrode plate 204 is disposed on the second surface. The electrode plate 204 includes a first electrode plate 2041, a second electrode plate 2043 around the first electrode plate 2041, and a first isolation plate 2042 disposed between an outer edge of the first electrode plate 2041 and an inner edge of the second electrode plate 2043. The outer edge of the second electrode plate 2043 is away from the first isolation plate 2042. Both the first electrode plate 2041 and the second electrode plate 2043 are electrically connected to the second circuit board 202.

FIG. 3 shows a cross-sectional view of the electrode plate and the conductor plate of some embodiments. The trend of the electric field lines between the electrode plate and the conductor plate is shown in FIG. 3. Taking the first electrode plate 2041 as the receiving electrode plate and the second electrode plate 2043 as the transmitting electrode plate for illustration, the electric field lines between the first electrode plate 2041, the second electrode plate 2043, and the conductor plate 203 first pass through the second electrode plate 2043 to the conductor plate 203, and then to the first electrode plate 2041. This causes the first electrode plate 2041 and the second electrode plate 2043 to be coupled through the conductor plate 203 to form a capacitor.

In some embodiments of the present disclosure, the first electrode plate 2041 and the second electrode plate 2043 form a nested structure. When a user presses different areas of the touchpad, the equivalent distance changes between the first electrode plate 2041, the second electrode plate 2043, and the conductor plate 203 are approximately the same, and the capacitance changes are also approximately the same, thereby improving the accuracy of pressure detection for the touchpad. Furthermore, the first isolation plate 2042 is disposed between the first electrode plate 2041 and the second electrode plate 2043, which isolates the first electrode plate 2041 and the second electrode plate 2043 from each other, thereby ensuring the accuracy of capacitance signal acquisition and further improving the accuracy of pressure detection for the touchpad.

In some embodiments, the electrode plate 204 and the second circuit board 202 are integrally formed, and the conductor plate 203 and the first circuit board 201 are integrally formed. This saves the volume of the touchpad and facilitates manufacturing, processing, and connection to the corresponding circuit boards. In some embodiments, the electrode plate 204 is disposed in the central area of the second circuit board 202, and the conductor plate 203 is disposed in the central area of the first circuit board 201, which is more conducive to improving the accuracy of touchpad pressure detection.

As shown in FIG. 2C, when a user applies the same pressing force at point C and point D, respectively, during pressing at point C, the pressing displacement at point C is y, and the pressing displacement gradually decreases in directions away from point C; during pressing at point D, the pressing displacement at point D is y, and the pressing displacement gradually decreases in directions away from point D. It can be seen that, due to the nested structure of the embodiments, when points C and D are pressed, substantially the same area of the first electrode plate 2041 and the second electrode plate 2043 may be driven to move downward. Therefore, under the same pressing force, the equivalent distance changes between the first electrode plate 2041 and the second electrode plate 2043 and the conductor plate 203 is substantially the same, and the resulting capacitance changes is also substantially the same, thereby improving the accuracy of pressure detection of the touchpad.

In practical applications, when the touchpad is provided on a laptop computer, different operations may be set according to different pressing pressures applied by the user, such as taking a screenshot, vibration feedback, increasing volume, decreasing volume, increasing screen brightness, and decreasing screen brightness. When the touchpad is installed on a game controller, different game skills can be triggered in response to different pressing pressures applied by the user to the touchpad. Therefore, by means of the above-described nested electrode plate 204 design, in some embodiments, the increasingly higher requirements of users at the current stage for the accuracy of touchpad pressure detection can be satisfied.

In some embodiments of the present disclosure, considering that the receiving electrode plate is connected to a processing unit and is responsible for transmitting capacitance signals received from the transmitting electrode plate to the processing unit, the first electrode plate 2041 serves as the receiving electrode plate and the second electrode plate 2043 serves as the transmitting electrode plate. That is, the receiving electrode plate is arranged inside the nested structure, which enables the receiving electrode plate to effectively isolate external signal interference and is more conducive to improving the anti-interference capability of the capacitive touchpad. In other embodiments, the positions of the transmitting electrode plate and the receiving electrode plate may also be interchanged; for example, the first electrode plate 2041 may serve as the transmitting electrode plate, and the second electrode plate 2043 may serve as the receiving electrode plate.

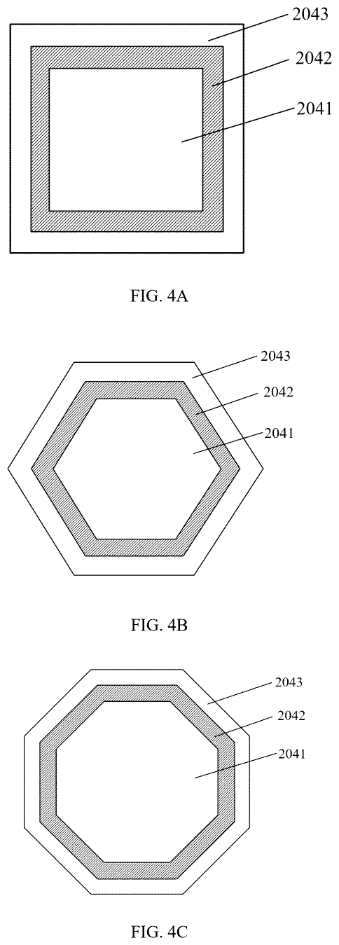

In some embodiments, a surface of the electrode plate 204 facing away from the second surface has any one of the following shapes: a regular quadrilateral, a regular hexagon, a regular octagon, or a circle. Taking the case where the surface of the electrode plate 204 facing away from the second surface is circular as an example, as shown in FIG. 2C, the electrode plate 204 has a nested circular structure. However, in practical applications, the electrode plate 204 may also have a regular quadrilateral structure as shown in FIG. 4A, a regular hexagonal structure as shown in FIG. 4B, or a regular octagonal structure as shown in FIG. 4C.

It should be noted that the surface of the electrode plate 204 facing away from the second surface may be defined as a third surface. The accuracy of touchpad pressure detection is related to an area of the third surface of the electrode plate 204. The larger the area of the third surface, the higher the accuracy of touchpad pressure detection; and the smaller the area of the third surface, the lower the accuracy of touchpad pressure detection. In some embodiments, the area of the third surface is set to be as large as possible, so as to improve the accuracy of touchpad pressure detection.

In some embodiments, as shown in FIG. 2A, the capacitive touchpad further includes a cover plate 200, and the cover plate 200 is disposed on a surface of the second circuit board 202 facing away from the bracket. The cover plate 200 defines an area for a user to touch the touchpad. By disposing the cover plate 200 on a surface of the second circuit board 202 facing away from the bracket, when the user presses the touchpad, the second circuit board 202 drives the electrode plate 204 structure to be pressed, thereby changing the capacitance of the capacitor assembly.

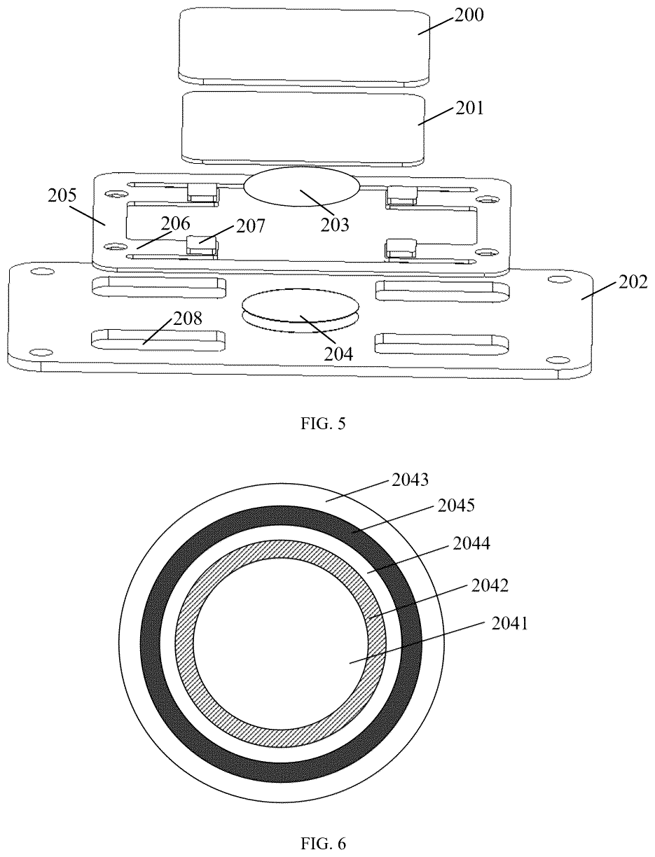

In some embodiments, the cover plate 200 may also be disposed on a surface of the first circuit board 201 facing away from the bracket. FIG. 5 shows a schematic structural view of a capacitive touchpad. The capacitive touchpad includes: a first circuit board 201, a second circuit board 202, a bracket (including a bracket body 205 and cantilever beams 206), and a capacitor assembly (including a conductor plate 203 and an electrode plate 204). A bracket is disposed between the first circuit board 201 and the second circuit board 202. The conductor plate 203 is disposed on a first surface of the first circuit board 201 facing the bracket, and the electrode plate 204 is disposed on a second surface of the second circuit board 202 facing the bracket, where the first surface and the second surface are disposed opposite to each other. The structure of the electrode plate 204 is the same as that shown in FIG. 2C in the above embodiments, and details thereof are not repeated herein. The difference between the embodiments shown in FIG. 5 and the above embodiments lies in that the positions of the conductor plate 203 and the electrode plate 204 are interchanged. That is, when the user presses the cover plate 200 of the touchpad, the first circuit board 201 drives the conductor plate 203 structure to be pressed, thereby changing the capacitance of the capacitor assembly.

In some embodiments, as shown in FIGS. 2A and 5, the bracket is a rectangular parallelepiped structure defining a cavity. The conductor plate 203 is located within the cavity, and the electrode plate 204 is also located within the cavity. That is, the conductor plate 203 is disposed on a portion of the first surface located in the cavity, and the electrode plate 204 is disposed on a portion of the second surface located in the cavity. The bracket includes a bracket body 205 and N cantilever beams 206 extending from the bracket body 205 toward the cavity, where N is a natural number greater than 0.

In one embodiment, for the touchpad shown in FIG. 2A, the second circuit board 202 is connected to free ends of the N cantilever beams 206 of the bracket. The first circuit board 201 is provided with N limiting holes 208 corresponding one-to-one to the N cantilever beams 206, and the cantilever beams 206 are configured to enter the limiting holes 208 respectively when the second circuit board 202 is pressed. In FIG. 2A, an example is illustrated in which the number of the cantilever beams 206 is four, and the cantilever beams 206 are respectively arranged at four vertices of the bracket. In practical applications, the positions and the number of the cantilever beams 206 may be set according to actual requirements, and are not specifically limited in this embodiment. In some embodiments, in a direction perpendicular to the first circuit board 201, a projection of the second circuit board 202 on the first circuit board 201 is located within the cavity. When a user presses the touchpad, after the surface of the cover plate 200 is subjected to pressure, the pressure is transmitted to the free ends of the cantilever beams 206 through the second circuit board 202, causing the cantilever beams 206 to bend and deform. Accordingly, the cover plate 200 and the second circuit board 202 move downward. Meanwhile, under the action of the pressure, the cantilever beams 206 bend and deform so as to enter the corresponding limiting holes 208. At this time, a distance between the electrode plate 204 and the conductor plate 203 is reduced, and the capacitance of the capacitor assembly increases. By detecting the capacitance value between the conductor plate 203 and the electrode plate 204, the pressure applied to the touchpad may be determined. In some embodiments, a respective elastic member 207 of elastic members 207 is disposed between the second circuit board 202 and each cantilever beam 206. The elastic members 207 may be springs, silicone pads, sponges, or other elastic structures, thereby protecting the second circuit board 202 and the cantilever beams 206 and improving the stability of the touchpad. It should be noted that, in some embodiments, in the direction perpendicular to the first circuit board 201, the projection of the second circuit board 202 on the first circuit board 201 is located within the cavity.

In some embodiments, as shown in the schematic structural view of the capacitive touchpad in FIG. 5, the first circuit board 201 is connected to the free ends of the N cantilever beams 206 of the bracket. The second circuit board 202 is provided with N limiting holes 208 corresponding one-to-one to the N cantilever beams 206, and the cantilever beams 206 are configured to enter the limiting holes 208 respectively when the first circuit board 201 is pressed. In some embodiments, in a direction perpendicular to the second circuit board 202, a projection of the first circuit board 201 on the second circuit board 202 is located within the cavity. When a user presses the touchpad, after the surface of the cover plate 200 is subjected to pressure, the pressure is transmitted to the free ends of the cantilever beams 206 through the first circuit board 201, causing the cantilever beams 206 to bend and deform. Accordingly, the cover plate 200 and the first circuit board 201 move downward. Meanwhile, under the action of the pressure, the cantilever beams 206 bend and deform so as to enter the corresponding limiting holes 208 respectively. At this time, a distance between the electrode plate 204 and the conductor plate 203 is reduced, and the capacitance of the capacitor assembly increases. By detecting the capacitance value between the conductor plate 203 and the electrode plate 204, the pressure applied to the touchpad may be determined. In some embodiments, a respective elastic member 207 of elastic members 207 is disposed between the first circuit board 201 and each cantilever beam 206. The elastic members 207 may be springs, silicone pads, sponges, or other elastic structures, thereby protecting the first circuit board 201 and the cantilever beams 206 and improving the stability of the touchpad. It should be noted that, in some embodiments, in the direction perpendicular to the second circuit board 202, the projection of the first circuit board 201 on the first circuit board 202 is located within the cavity.

In some embodiments, in a direction perpendicular to the first surface of the first circuit board 201, a projection of the electrode plate 204 on the first circuit board 201 is located within a projection of the conductor plate 203 on the first circuit board 201. That is, when viewed from a top view, an area of the conductor plate 203 is larger than an area of the electrode plate 204, and the conductor plate 203 covers the electrode plate 204, such that each region of the first electrode plate 2041 and the second electrode plate 2043 of the electrode plate 204 is disposed opposite to the conductor plate 203. As a result, during capacitance detection, the accuracy of detecting capacitance variation is relatively high, thereby improving the accuracy of pressure detection of the touchpad.

FIG. 6 is a schematic top view of the electrode plate of a capacitive touchpad according to some embodiments of the present disclosure. Specifically, the electrode plate 204 not only includes a first electrode plate 2041, a first isolation plate 2042, and a second electrode plate 2043, but also includes a grounding plate 2044 and a second isolation plate 2045 disposed between the first isolation plate 2042 and the second electrode plate 2043. The grounding plate 2044 is arranged around an edge of the first isolation plate 2042 facing away from the first electrode plate 2041, the second isolation plate 2045 is arranged around an edge of the grounding plate 2044 facing away from the first isolation plate 2042, and the second electrode plate 2043 is arranged around an edge of the second isolation plate 2045 facing away from the grounding plate 2044. FIG. 6 illustrates the electrode plate 204 as having a circular shape as an example. The electrode plate 204 may also have other shapes, such as a regular quadrilateral, a regular hexagon, or a regular octagon.

In the embodiments of the present disclosure, by sequentially nesting the first electrode plate 2041, the first isolation plate 2042, the grounding plate 2044, the second isolation plate 2045, and the second electrode plate 2043, not only is the accuracy of pressure detection of the touchpad improved, but the first electrode plate 2041 and the second electrode plate 2043 are further isolated by the first isolation plate 2042, the grounding plate 2044, and the second isolation plate 2045, thereby further improving the accuracy of capacitive signal acquisition.

In some embodiments, the first electrode plate 2041 serves as a receiving electrode plate, and the second electrode plate 2043 serves as a transmitting electrode plate. That is, the receiving electrode plate is disposed at the innermost portion of the nested structure, followed sequentially by the first isolation plate 2042, the grounding plate 2044, and the second isolation plate 2045. In this way, not only are the first electrode plate 2041 and the second electrode plate 2043 isolated, but the grounding plate 2044 also isolates direct coupling between the first electrode plate 2041 and the second electrode plate 2043, thereby more effectively enabling the receiving electrode plate to be isolated from interference from the transmitting electrode plate and external signals, increasing the proportion of effective signals, and further improving the anti-interference capability of the capacitive touchpad. In other embodiments, the positions of the transmitting electrode plate and the receiving electrode plate may also be interchanged; for example, the first electrode plate 2041 may serve as the transmitting electrode plate, and the second electrode plate 2043 may serve as the receiving electrode plate.

In another aspect, in the embodiments of the present disclosure, an electronic equipment, including the capacitive touchpad described above is further provided.

Compared with the related art, since the electronic equipment provided in some embodiments of the present disclosure is provided with the capacitive touchpad according to the foregoing embodiments, it likewise achieves the technical effects of the foregoing embodiments, which are not repeated herein.

The division of the various components described above is merely for clarity of description. In implementation, the components may be combined into a single component or certain components may be separated and divided into multiple components. As long as the same logical relationships are included, such implementations fall within the protection scope of the present embodiments.

Those skilled in the art may understand that the above embodiments are specific embodiments for implementing the present disclosure, and that various changes in form and details may be made in practical applications without departing from the spirit and scope of the present disclosure.

What is claimed is:

1. A capacitive touchpad, comprising:
a first circuit board,
a second circuit board,
a bracket, and
a capacitor assembly; wherein:
the bracket is disposed on a first surface of the first circuit board, and the second circuit board is disposed on a side of the bracket away from the first surface, wherein a second surface of the second circuit board faces the first surface and the bracket;
the capacitor assembly comprises a conductor plate and an electrode plate opposite to the conductor plate, the conductor plate is disposed on the first surface and the electrode plate is disposed on the second surface;
the electrode plate comprises a first electrode plate, a second electrode plate around the first electrode plate, and a first isolation plate disposed between an outer edge of the first electrode plate and an inner edge of the second electrode plate, an outer edge of the second electrode plate being away from the first isolation plate, and the first electrode plate and the second electrode plate are both electrically connected to the second circuit board.

2. The capacitive touchpad according to claim 1, wherein, the first electrode plate is a receiving electrode plate, the second electrode plate is a transmitting electrode plate.

3. The capacitive touchpad according to claim 2, wherein, the electrode plate further comprises a grounding plate and a second isolation plate disposed between the first isolation plate and the second electrode plate,
wherein the grounding plate is arranged around an edge of the first isolation plate facing away from the first electrode plate, the second isolation plate is arranged around an edge of the grounding plate facing away from the first isolation plate, and the second electrode plate is arranged around an edge of the second isolation plate facing away from the grounding plate.

4. The capacitive touchpad according to claim 1, wherein a surface of the electrode plate facing away from the second surface has any one of the following shapes: a regular quadrilateral, a regular hexagon, a regular octagon, or a circle.

5. The capacitive touchpad according to claim 1, wherein the capacitive touchpad further comprises a cover plate, and the cover plate is disposed on a surface of the second circuit board facing away from the bracket.

6. The capacitive touchpad according to claim 1, wherein the bracket is a rectangular parallelepiped structure having a cavity, the conductor plate is disposed within the cavity, and the electrode plate is disposed within the cavity.

7. The capacitive touchpad according to claim 6, wherein the bracket includes a bracket body and N cantilever beams extending from the bracket body toward the cavity, and N is a natural number greater than 0;
wherein the second circuit board is connected to free ends of the N cantilever beams of the bracket, and the first circuit board is provided with N limiting holes corresponding one-to-one to the N cantilever beams, with the cantilever beams 206 being configured to enter the limiting holes respectively in response to the second circuit board being pressed.

8. The capacitive touchpad according to claim 7, wherein a respective elastic member of elastic members is disposed between the second circuit board and each of the cantilever beams.

9. The capacitive touchpad according to claim 1, in a direction perpendicular to the first surface of the first circuit board, a projection of the electrode plate on the first circuit board is located within a projection of the conductor plate on the first circuit board.

10. An electronic equipment, comprising the capacitive touchpad according to claim 1.
